(19) United States
(12) Patent Application Publication
(10) Pub. No.: US 2026/0163261 A1
(43) Pub. Date: Jun. 11, 2026

(54) METHOD OF FORMING ELECTRICAL COMPONENT WITH IMPROVED SEALING

(71) Applicant: ELECTRICAL COMPONENTS INTERNATIONAL, INC., St. Louis, MO (US)

(72) Inventor: Duncan Whitelaw, Ingersoll (CA)

(21) Appl. No.: 19/340,215

(22) Filed: Sep. 25, 2025

Related U.S. Application Data
(60) Provisional application No. 63/728,511, filed on Dec. 5, 2024.

(51) Int. Cl. H01R 4/72; H01H 37/00; H01R 13/52; H01R 13/684; H05B 6/64

(52) U.S. Cl. CPC H01R 4/72; H01H 37/002; H01R 13/5221; H01R 13/684; H05B 6/6491

(57) ABSTRACT

A tool for heat staking a tubing about a wire includes a tool body having a RF heat applying section with lateral sides having a generally planar surface and a heat applying portion formed about a cylindrical surface. The cylindrical surface is designed to be between 105 and 115 percent of a radius of a wire which is to be heat staked to a tubing. A method is also disclosed.

### CROSS-REFERENCE TO RELATED APPLICATIONS

This application claims priority to U.S. Provisional Application No. 63/728,511 filed Dec. 5, 2024.

### BACKGROUND

This application relates to a tool and a method for sealing a thermal fuse using radio frequency.

Thermal fuses are known, and utilized in any number of modern applications. As one example, a thermal fuse may be utilized in an appliance. The thermal fuse is positioned between an appliance, and a source of power. The thermal fuse is spliced to a wire heading to the appliance, and to a wire from the power source.

A thermal fuse is a safety device which will open when a set temperature is exceeded for set period of time. Typically a thermal fuse must be replaced when it is opened.

It is known in the art to provide sealing of the thermal fuse with tubing. A glue requires heat to be applied to shrink the tube. In the prior art the heat has been applied to the thermal fuse itself.

The heat may exceed a trip temperature for the thermal fuse, but usually not for the period of time required to trip the fuse. This may leave the fuse in partially tripped state. This could impact the behavior of the thermal fuse to substantially deviate from a specified behavior.

### SUMMARY

In one exemplary embodiment, a tool for heat staking a tubing about a wire includes a tool body having a RF heat applying section with lateral sides having a generally planar surface and a heat applying portion formed about a cylindrical surface. The cylindrical surface is designed to be between 105 and 115 percent of a radius of a wire which is to be heat staked to a tubing.

In a further embodiment of any of the above, the tool body includes two of the heat applying surfaces, such that a heat stake can be formed on each side of a thermal fuse.

In a further embodiment of any of the above, the heat stakes are formed outwardly of a splice that splices the thermal fuse to a pair of wires.

In a further embodiment of any of the above, the tube body includes arms extending away from the tube body and including the heat applying portion with the general planar lateral sides being on the arms.

In a further embodiment of any of the above, an RF control and movement tool is attached to create RF heat in the arms of the tool, and move the tool toward a wire received within a tubing to be heat staked.

In a further embodiment of any of the above, a pair of the tools are positioned on opposed sides of the wire and the tubing.

In a further embodiment of any of the above, the heat applying portion includes countersunk ends which have a greater radius than the cylindrical surface.

In a further embodiment of any of the above, the countersunk ends are frusto-conical.

In a further embodiment of any of the above, the tube body includes arms extending away from the tube body and including the heat applying portion with the general planar lateral sides being on the arms.

In a further embodiment of any of the above, the tube body includes arms extending away from the tube body and including the heat applying portion with the general planar lateral sides being on the arms.

In another exemplary embodiment, a method of forming a component lead wire includes the steps of crimping a first lead wire from an electrical component at a first crimp to a component lead wire to be connected to a component, crimping a second lead wire from the electrical component to a power lead line to be connected with a source of power at a second crimp, positioning a protective material outwardly of the electrical component, and heat staking the protective material to one of the component and first lead lines at a location spaced from the electrical component and also heat staking one of the power and second lead lines at a location spaced from the electrical component, the heat staking being performed by a tool for heat staking a tubing about a wire including and a tool body having a RF heat applying section with lateral sides with a generally planar surface and a heat applying portion formed about a cylindrical surface, and the cylindrical surface being designed to be between 105 and 115 percent of a radius of a wire which is to be heat staked to a tubing.

In a further embodiment of any of the above, the tool body includes two of the heat applying surfaces, such that a heat stake can be formed on each side of the electrical component.

In a further embodiment of any of the above, the electrical component is a thermal fuse, and the heat stakes are formed outwardly of a splice that splices the thermal fuse to a pair of wires.

In a further embodiment of any of the above, the tube body includes arms extending away from the tube body and including the heat applying portion with the general planar lateral sides being on the arms.

In a further embodiment of any of the above, an RF control and movement tool is attached to create RF heat in the arms of the tool, and move the tool toward a wire received within a tubing to be heat staked.

In a further embodiment of any of the above, a pair of the tools are positioned on opposed sides of the wire and the tubing.

In a further embodiment of any of the above, the heat applying portion includes countersunk ends which have a greater radius than the cylindrical surface.

In a further embodiment of any of the above, the countersunk ends are frusto-conical.

In a further embodiment of any of the above, the tube body includes arms extending away from the tube body and including the heat applying portion with the general planar lateral sides being on the arms.

In a further embodiment of any of the above, the tube body includes arms extending away from the tube body and including the heat applying portion with the general planar lateral sides being on the arms.

These and other features will be best understood from the following drawings and specification, the following is a brief description.

### BRIEF DESCRIPTION OF THE DRAWINGS

FIG. 1 schematically shows a power supply to a component.

FIG. 2 shows a thermal fuse sealing method according to this disclosure.

FIG. 3 is an end view of a tool for forming the thermal fuse seal of FIG. 2.

FIG. 4 is a side view of the tool of FIG. 3.

FIG. 5 is an end view of the tool.

FIG. 6 shows the location of a pair of tools on the thermal fuse of FIG. 2.

FIG. 7 shows a further detail of a method of forming the seal.

### DETAILED DESCRIPTION

A thermal fuse 26 is employed in a system 20. The system 20 includes a component 22 to receive power. Example components may be an appliance that is heat producing, such as, hair dryers, clothes dryers, etc. A power source 24 communicates to the component 22 through a thermal fuse 26. Electric lead line 28 from the thermal fuse 26 is crimped at 34 to the electrical line 32 leading to the component 22. Similarly, a lead 30 into the thermal fuse 26 is crimped at 36 to a line 38 from the power source 24. Line 38 may include an electrical plug.

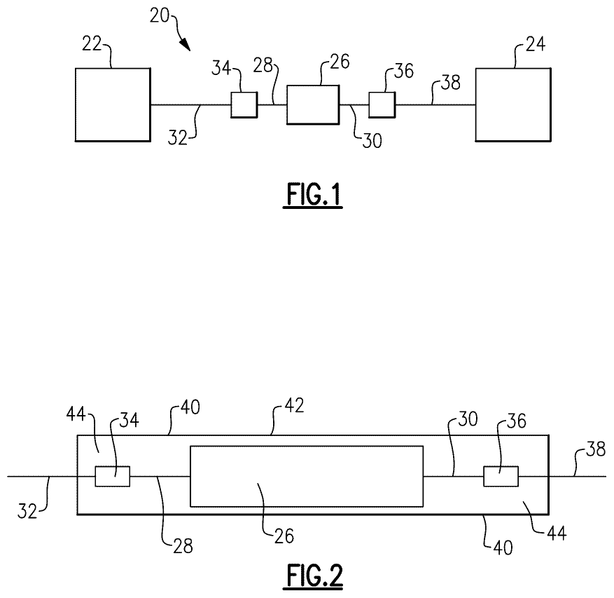

FIG. 2 shows a detail of the thermal fuse 26 and splices 34 and 36. Outer tubing 40 and 42 extends beyond the splices 34 and 36, and enclose the fuse 26.

However, contrary to the prior art mentioned above, there is now heat staking at ends 44 which are on opposed sides of the splices 34 and 36 relative to the thermal fuse 26.

Now heat is not applied to the portion 42 of the tubing surrounding the thermal fuse 26.

The problem mentioned above with regard to applying heat to the thermal fuse is avoided.

The tubing 40/42 may be clear polyvinyl chloride (“PVC”) tubing.

A tool 50 for forming the thermal seals is shown in FIG. 3. The tool 50 has end portions 52 and 54 on both sides of a pair of RF heat applying sections or arms 56. An intermediate portion 58 separates the sections 56. Sections 56 each include a RF heat applying portion 60 having a countersunk area 62 and 64 and a central portion 66. The heat applying portion 66 is what will actually provide the heat seal about the wire, as described below. Portions of the arms 56 outwardly of the portions 66 stake the tubing laterally outwardly of the tubing outwardly of the wires.

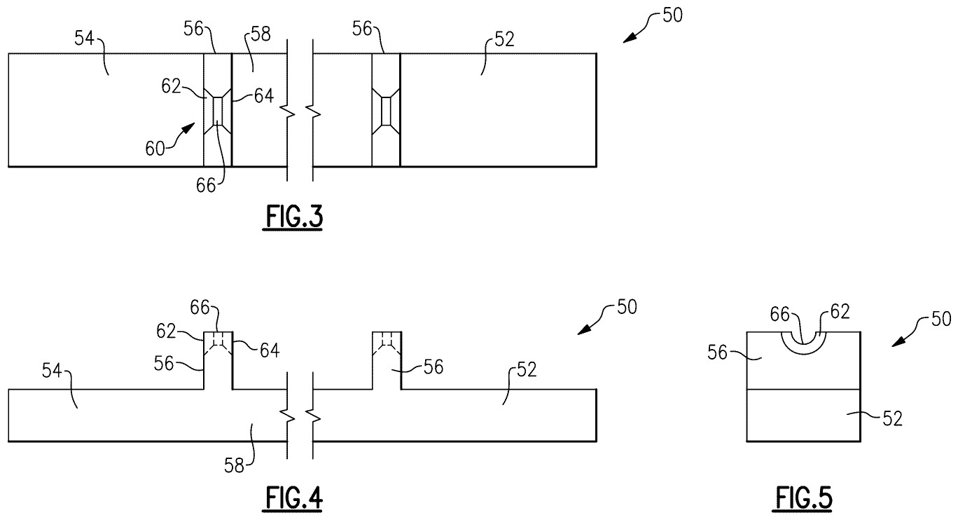

FIG. 4 is a side view of tool 50. As can be seen, there are arms 56 extending upward from a body forming portions 52, 54 and 58. The countersunk portions 62 and 64 are illustrated along with the heat applying portions 66.

FIG. 5 is an end view of the tool 50 and shows one of the arms 56 having countersunk portions 62 extending about 180 degrees, and away from the heat applying portion 66, which has a radially smaller inner radius. By forming the countersunk portions 62 and 64 the amount of surface area that will be close to contacting the wire will be reduced, thus reducing the likelihood of any damage.

In embodiments, a radius of the section 66 will be selected to be between 105 and 115 percent of a radius of the particular wire which will be used in the component. In one embodiment, the radius might be 110 percent of the radius of the wire.

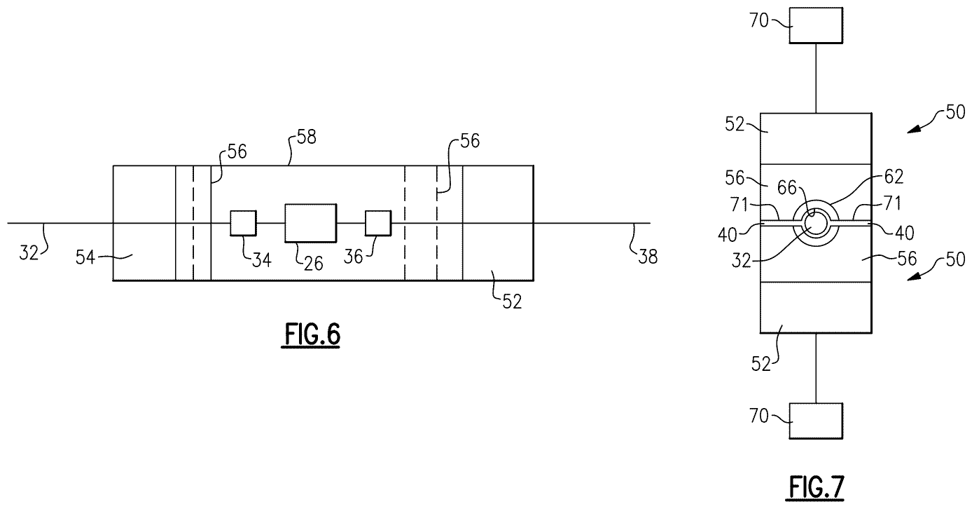

As shown in FIG. 6, the arms 56 are positioned outwardly of the splices 34 and 36.

As shown in FIG. 7, there are actually a pair of tools 50 associated with controls and tools 70 which provide the radio frequency force and heat to the tools 50, and move the tools 50 such that they closely surround the wire 32 and tubing 40. The sides 71 of the tool laterally outwardly of the portion 60 stake the tubing 40, and the heat applying section 66 stakes the tubing about the wire 32. The sides 71 are planar.

While the method and tool are disclosed with a thermal fuse, they could also extend to other components, including resistors, capacitor, diodes and other electrical components.

Although embodiments have been disclosed, a worker of skill in this art would recognize that modifications would come within the scope of this disclosure. For that reason the following claims should be studied to determine the true scope and content of this disclosure.

What is claimed is:

1. A tool for heat staking a tubing about a wire comprising:
a tool body having a RF heat applying section with lateral sides having a generally planar surface and a heat applying portion formed about a cylindrical surface, and the cylindrical surface being designed to be between 105 and 115 percent of a radius of a wire which is to be heat staked to a tubing.

2. The tool as set forth in claim 1, wherein the tool body includes two of the heat applying surfaces, such that a heat stake can be formed on each side of a thermal fuse.

3. The tool as set forth in claim 2, wherein the heat stakes are formed outwardly of a splice that splices the thermal fuse to a pair of wires.

4. The tool as set forth in claim 1, wherein the tube body includes arms extending away from the tube body and including the heat applying portion with the general planar lateral sides being on the arms.

5. The tool as set forth in claim 4, wherein an RF control and movement tool is attached to create RF heat in the arms of the tool, and move the tool toward a wire received within a tubing to be heat staked.

6. The tool as set forth in claim 1, wherein a pair of the tools are positioned on opposed sides of the wire and the tubing.

7. The tool as set forth in claim 1, wherein the heat applying portion includes countersunk ends which have a greater radius than the cylindrical surface.

8. The tool as set forth in claim 7, wherein the countersunk ends are frusto-conical.

9. The tool as set forth in claim 8, wherein the tube body includes arms extending away from the tube body and including the heat applying portion with the general planar lateral sides being on the arms.

10. The tool as set forth in claim 7, wherein the tube body includes arms extending away from the tube body and including the heat applying portion with the general planar lateral sides being on the arms.

11. A method of forming a component lead wire comprising the steps of:
crimping a first lead wire from an electrical component at a first crimp to a component lead wire to be connected to a component;
crimping a second lead wire from the electrical component to a power lead line to be connected with a source of power at a second crimp;
positioning a protective material outwardly of the electrical component, and heat staking the protective material to one of the component and first lead lines at a location spaced from the electrical component and also heat staking one of the power and second lead lines at a location spaced from the electrical component;
the heat staking being performed by a tool for heat staking a tubing about a wire comprising: and
a tool body having a RF heat applying section with lateral sides with a generally planar surface and a heat applying portion formed about a cylindrical surface, and the cylindrical surface being designed to be between 105 and 115 percent of a radius of a wire which is to be heat staked to a tubing.

12. The method as set forth in claim 11, wherein the tool body includes two of the heat applying surfaces, such that a heat stake can be formed on each side of the electrical component.

13. The method as set forth in claim 12, wherein the electrical component is a thermal fuse, and the heat stakes are formed outwardly of a splice that splices the thermal fuse to a pair of wires.

14. The method as set forth in claim 11, wherein the tube body includes arms extending away from the tube body and including the heat applying portion with the general planar lateral sides being on the arms.

15. The method as set forth in claim 14, wherein an RF control and movement tool is attached to create RF heat in the arms of the tool, and move the tool toward a wire received within a tubing to be heat staked.

16. The method as set forth in claim 11, wherein a pair of the tools are positioned on opposed sides of the wire and the tubing.

17. The method as set forth in claim 11, wherein the heat applying portion includes countersunk ends which have a greater radius than the cylindrical surface.

18. The method as set forth in claim 17, wherein the countersunk ends are frusto-conical.

19. The method as set forth in claim 18, wherein the tube body includes arms extending away from the tube body and including the heat applying portion with the general planar lateral sides being on the arms.

20. The method as set forth in claim 17, wherein the tube body includes arms extending away from the tube body and including the heat applying portion with the general planar lateral sides being on the arms.
